(19) United States
(12) Patent Application Publication
(10) Pub. No.: US 2026/0340955 A1
(43) Pub. Date: Oct. 29, 2026

(54) Adaptive VR Interaction System

(71) Applicant: Hoi Fung Everest WONG, Monterey Park, CA (US)

(72) Inventor: Hoi Fung Everest WONG, Monterey Park, CA (US)

(21) Appl. No.: 19/189,278

(22) Filed: Apr. 25, 2025

(51) Int. Cl. G06T 19/00; G06F 3/01; G06F 8/36; G06F 11/34; G06K 19/06

(52) U.S. Cl. CPC G06T 19/006; G06F 3/017; G06F 8/36; G06F 11/3438; G06K 19/06037

(57) ABSTRACT

The disclosed system integrates Dynamic Interaction Specifications (DIS) to facilitate high-level intents within virtual reality (VR) environments. It comprises a control device and an output device, such as a VR headset, connected via a server. The server includes an AI-powered code generator and a code database storing Accessibility Link Codes, which encode high-level intents derived from user interface elements. These intents are translated into platform-specific commands executable by the control and output devices, enabling adaptive and accessible interactions. The system employs persistent communication protocols, such as WebSocket, HTTP/2, or gRPC, to maintain continuous, bidirectional connections between devices. The disclosed embodiments support multimodal feedback, including visual, auditory, and haptic cues, and dynamically adjust interactions based on user behaviors and device capabilities. This approach enhances usability, accessibility, and adaptability across diverse VR platforms, providing a seamless and intuitive user experience by abstracting interactions into high-level intents.

### FIELD OF INVENTION

The present invention relates generally to enabling seamless interaction between users and VR applications through platform-agnostic commands.

### BACKGROUND OF THE INVENTION

The proliferation of digital interfaces across platforms, including traditional 2D web environments, immersive VR spaces, and AI-driven systems, has led to a variety of interaction methods tailored to different combinations of display and control devices. These include monitors paired with keyboards and mice, VR headsets with 6-DoF VR gamepads, and audio screen readers with microphones. While these technological advancements offer new ways to engage with digital content, they also present significant challenges in delivering a consistent, accessible, and intuitive user experience, particularly for individuals with disabilities.

One major issue is the fragmented nature of existing accessibility solutions, which are primarily designed for conventional 2D interfaces and rely heavily on visual interactions and linear navigation methods. These tools are often inadequate for users with limited vision, as they do not effectively support the complex spatial interactions required in VR environments. In VR, navigation depends on spatial awareness and the ability to interact within a 3D space using VR headsets and 6-DoF VR gamepads. Users with limited vision or those who are accustomed to screen readers face significant barriers in these immersive environments, where conventional accessibility tools fail to translate effectively.

In addition to accessibility limitations, the inconsistency of user experiences across different platforms exacerbates these challenges. Each environment, whether a 2D interface or a VR space, employs distinct interaction paradigms, forcing users to adapt to varying controls, navigation styles, and content formats. This inconsistency can lead to cognitive overload, especially for users who struggle with complex interfaces or tasks that involve multiple steps. The varying demands of each platform can overwhelm users with cognitive limitations, making interactions less intuitive and more difficult to manage.

Managing interactions between diverse combinations of display and control devices further complicates accessibility. Conventional systems often lack the capability to intelligently pair these devices in a way that optimizes the user experience. This limitation is particularly pronounced for users with dexterity limitations or those who have difficulty with fine motor skills, such as thumb or finger movements. For instance, the precise controls required by 6-DoF VR gamepads may be challenging for users with dexterity issues, just as using a microphone with a conventional 2D web interface may not provide an efficient means of interaction. This highlights the need for systems that can accommodate a wide range of input methods, tailored to the specific capabilities and limitations of the user.

Furthermore, current systems frequently struggle with delivering content that is appropriately tailored to the user's device configuration and interaction needs. This lack of context-aware content delivery often results in suboptimal user experiences, such as presenting complex visual data to users with limited vision or providing non-immersive content through a VR headset. The inability to dynamically adjust content based on the user's requirements and the capabilities of their display and control devices significantly reduces accessibility and usability.

Moreover, the high cognitive load associated with conventional navigation methods, such as screen readers, poses a substantial barrier to effective digital interactions. These methods typically require users to process information sequentially, which can be slow and mentally taxing, especially when navigating through complex or lengthy interfaces. For users with cognitive limitations or those who experience cognitive overload, this linear approach can lead to fatigue, errors, and decreased satisfaction with the digital experience.

These challenges underscore the urgent need for an integrated and adaptive system that can unify interaction paradigms across various platforms and device configurations.

### SUMMARY OF THE INVENTION

The present invention pertains to a Semantic Interaction System that enhances accessibility and interaction across various environments, including 2D user interfaces, VR/AR platforms, and AI-driven systems. Traditional accessibility tools, such as screen readers, often struggle with the complexities of spatial interactions in VR environments, and conventional 2D interfaces heavily rely on visual elements like buttons and forms, which can present challenges for users with visual impairments or cognitive overload. This system addresses these limitations by introducing Dynamic Interaction Specifications (DIS), generated by advanced Large Language Models (LLMs). DIS abstracts user interactions into high-level intents, simplifying detailed UI navigation into manageable operations controllable through various input methods.

At the core of this system is the use of DIS, which provides a flexible and adaptable framework for defining user interactions across diverse platforms. By abstracting detailed interactions into platform-independent representations, DIS allows for consistent and simplified user experiences across different environments, including VR, AR, 2D, and voice-driven interfaces.

Central to the system are Accessibility Link Codes, often implemented as QR codes, which go beyond simple connection tools. These codes encapsulate the relationships between control devices (e.g., voice commands, touch interfaces), output devices (e.g., VR headsets, screen readers), and the application's functionality as defined by DIS. When scanned, Accessibility Link Codes provide detailed compatibility information, guiding users on which devices are best suited for specific app functions and how they interact seamlessly with the defined high-level intents. This enables users to easily identify compatible devices, understand application capabilities, and make informed decisions about their interaction options.

Custom Connectors, generated by an AI-powered code generator, play a critical role by translating the platform-independent actions defined by DIS into device-specific commands that align with the capabilities identified by the Accessibility Link Codes. These connectors dynamically adapt interactions across various devices, ensuring that high-level intents are executed consistently, regardless of the differences in device interfaces or functionalities. By leveraging AI, particularly the capabilities of LLMs, the system creates connectors that support a broad range of devices, facilitating an adaptable and inclusive user experience.

The system's content delivery is managed through the content control logic of the matching engine, which applies business rules to tailor content to the specific capabilities and contexts of the user's devices. This ensures that content is not only accessible but also optimized for the user's environment, addressing common accessibility barriers found in traditional systems that do not adjust content for specific needs, such as visual impairments, dexterity limitations, or cognitive challenges.

Overall, the Semantic Interaction System integrates Dynamic Interaction Specifications (DIS) generated by LLMs, Accessibility Link Codes, and AI-generated Custom Connectors into a unified framework that significantly improves accessibility, usability, and consistency across 2D, VR, and AI-driven environments. By dynamically adapting to user preferences, device configurations, and application requirements, the system offers a seamless, user-centric approach to managing diverse digital interactions. This innovative framework sets a new standard for accessible digital experiences, enabling users of all abilities to engage with technology in ways that are intuitive, adaptable, and personalized to their needs.

### BRIEF DESCRIPTION OF DRAWINGS

FIG. 1(a) illustrates an exemplary control device.

FIG. 1(b) illustrates an exemplary externally connected device useable with the control device.

FIG. 2 illustrates a system for connecting to and controlling an output device via a control device, in accordance with an embodiment.

FIG. 3 illustrates a method for connecting to and controlling an output device via a control device, in accordance with an embodiment.

FIG. 4 illustrates another method for connecting to and controlling an output device via a control device, in accordance with an embodiment.

FIG. 5 illustrates a method for mapping UI elements into platform-independent representations, in accordance with an embodiment.

FIG. 6 illustrates a method involving the use of Custom Connectors for platform-specific execution, in accordance with an embodiment.

FIG. 7 illustrates a method for supporting users with dexterity limitations in VR environments through the use of point-and-click interactions, auto-overlay features, and action chaining, in accordance with an embodiment.

### DETAILED DESCRIPTION OF THE INVENTION

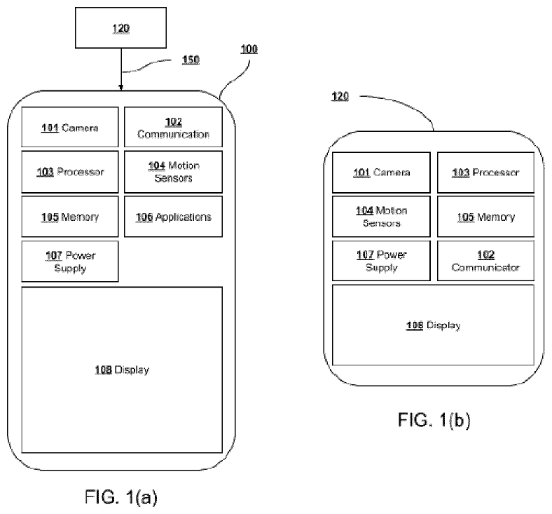

In one embodiment, the disclosed system pertains to integrating Dynamic Interaction Specifications (DIS) to facilitate high-level intents within a virtual reality (VR) environment, comprising a control device 100 and an output device 120, as illustrated in FIG. 1(a) and FIG. 1(b). The control device 100 may include various types of devices, such as smartphones, tablets, dedicated VR controllers, pointing devices, and other input mechanisms equipped with components like a camera 101, a communication interface 102, and a processor 103 implemented as a system-on-a-chip. Additional features include motion sensors 104, such as gyroscopes and accelerometers, and a memory 105 for storing applications 106 that execute functionalities of the disclosed system, including capturing images, transmitting data, and facilitating user interactions through multiple input/output modalities like a touchscreen display 108. In one embodiment, the pointing devices may include a virtual joystick interface developed using the Light and Versatile Graphics Library (LVGL), which replicates common mobile gaming interfaces and allows users to control movements by touching and dragging a handler on the screen. This virtual joystick addresses the need for joystick functionality within the LVGL framework and is particularly suitable for integration in projects, such as VR applications. The system is configured to leverage hardware that supports multi-touch input, such as displays equipped with GT911 touch drivers capable of detecting up to five touchpoints, thereby enhancing the versatility and user experience of the control device within the VR environment

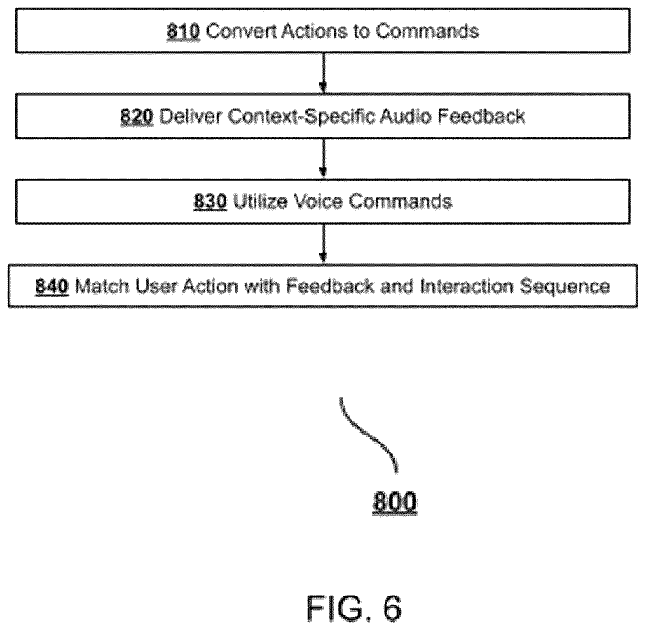

The Dynamic Interaction Specification (DIS) serves as a flexible framework within the Semantic Interaction System 200, enabling the abstraction of user interactions from specific device functionalities. Unlike traditional API specifications, which define fixed commands, endpoints, and parameters, DIS does not confine interactions to predefined sequences or specific implementations. Instead, DIS maps user interface elements to high-level intents, allowing for platform-independent interaction flows that are adaptable and consistent across various control and output devices, such as VR headsets and pointing devices, as shown in FIG. 6. For example, a high-level intent like “Subscribe to News Updates” can be represented as EXECUTE_COMMAND with parameters such as COMMAND_TYPE=Subscribe and TARGET=News Updates, without binding to specific API commands or endpoints.

The output device 120, as depicted in FIG. 1(b), includes VR headsets, tablets, web-enabled LCD televisions, and other immersive display technologies. These output devices typically comprise high-definition displays 108, communication interfaces 102, processors 103, memory 105, and power supplies 107. The output devices are configured to deliver immersive experiences by interfacing with control devices 100, enabling the execution of commands derived from high-level intents via DIS. For instance, a VR headset interprets the command “select object” and translates it into specific actions that allow the user to interact with the virtual environment, thus enhancing the immersive quality and usability of the VR system.

Central to the system is the server 310, which houses an AI-powered code generator that dynamically creates Custom Connectors. These Custom Connectors are critical in translating high-level intents encoded in Accessibility Link Codes into platform-specific commands executable by both the VR headset and the pointing device. The code database 330 stores the Accessibility Link Codes, associating them with the VR headset and the pointing device, facilitating the translation of server application SDKs 370 and their associated APIs into high-level intents. The server is configured to receive user inputs from the pointing device, process these inputs through the AI-powered code generator, and utilize the resulting Custom Connectors to execute platform-specific commands on the output device 120, ensuring seamless and responsive user interactions.

Large Language Models (LLMs), such as GPT-4, are central to the generation of Dynamic Interaction Specifications (DIS). These models are trained on extensive datasets that include a vast array of text and interaction data, covering diverse user behaviors, intents, commands, and contextual nuances across different platforms and devices. The training process involves feeding the LLMs with billions of data points from sources such as user interface interactions, application command logs, technical documentation, and various forms of structured and unstructured data.

The training methodology typically employs supervised learning, unsupervised learning, and reinforcement learning techniques to enable the LLMs to learn the relationships between user intents and their corresponding actions. By utilizing advanced machine learning algorithms, such as transformer architectures, the LLMs develop a deep understanding of language patterns, user intent recognition, and the ability to generalize across multiple contexts and platforms. This robust training enables the LLMs to create DIS that abstract user interactions into high-level intents, which are not tied to any specific hardware or software constraints.

Furthermore, the LLMs are continuously refined through iterative feedback loops that incorporate user interaction data and performance metrics from real-world deployments. This ongoing refinement allows the models to adapt to evolving user behaviors and emerging interaction paradigms, ensuring that the DIS remains relevant and effective. The ability of the LLMs to generate high-level intents that are adaptable and interpretable by a wide range of devices, including VR headsets and pointing devices, is a direct result of this comprehensive training process.

To enhance the immersive experience, the system integrates feedback mechanisms, including haptic feedback from the control device (such as vibrations or tactile responses) and visual or auditory feedback from the VR headset, reinforcing the user's sense of presence within the VR environment. The content control logic within the system dynamically adjusts content delivery based on user actions and feedback from the VR environment, ensuring that interactions remain smooth and consistent. The system continuously monitors and optimizes the performance of connections between control and output devices, reducing latency to maintain the immersive quality essential in VR settings.

Additionally, the control device 100 and output device 120 are configured to support Accessibility Link Codes, which encode detailed compatibility and capability information. This ensures that content delivery is tailored to each user's needs, with a particular emphasis on accessibility features for users with specific requirements, such as those with visual impairments. The system's architecture emphasizes compatibility and adaptability across diverse platforms and interaction modalities, leveraging dynamically generated Custom Connectors to translate high-level intents into platform-specific commands that are tailored to the user's context and device capabilities.

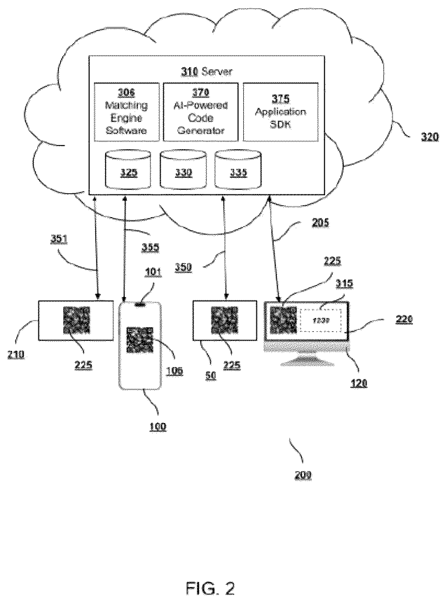

FIG. 2 illustrates the architecture of the Semantic Interaction System 200, which facilitates connectivity and control between control devices 100 and output devices 120 through a server 310. The system is composed of three primary components: control devices 100, the server 310, and output devices 120. The server 310 includes an AI-powered code generator 370 that dynamically creates Custom Connectors, as well as a matching engine 306 that manages connections across multiple users, coordinating content delivery to the respective output devices 120. The matching engine 306 interfaces with a user database 325, a code database 330, and a content database 335. This configuration enables the system to utilize Dynamic Interaction Specifications (DIS) to define high-level intents that guide adaptive and platform-independent interactions between the control devices 100 and output devices 120.

The user database 325 stores user-specific information, including credentials, preferences, interaction histories, and settings. This allows the system to dynamically personalize the user experience based on high-level intents defined by DIS, ensuring that each interaction aligns with the user's preferences and requirements. The content database 335 stores various types of content, including text, graphics, video, multimedia, and other interactive elements. This content is generated and optimized using SDKs 370 from applications such as websites or web apps, and is adapted through APIs that map user interface elements into platform-independent representations. These representations are facilitated by Custom Connectors that execute the content delivery on the appropriate control and output devices, thereby ensuring that the high-level intents are accurately reflected across all connected devices.

The code database 330 is configured to store Accessibility Link Codes, which are implemented as unique codes 315, often represented by QR codes 225. These codes are mapped to specific WebSocket server ports 350 corresponding to the output devices 120, allowing precise content delivery based on the high-level intents specified by DIS. Each Accessibility Link Code encodes high-level intents derived from user interactions within the VR environment. The control devices 100, equipped with application software 106 and a camera 101, are configured to scan these codes 315, which may be displayed on an output device 120, a dedicated code output device 210, or another medium 50. Upon scanning, the control device 100 initiates a connection with the server 310 via a WebSocket 355, establishing real-time, bi-directional communication and control over the output devices 120.

The WebSocket 355 operates as a bi-directional, full-duplex communication protocol over a single Transmission Control Protocol (TCP) connection, standardized by the Internet Engineering Task Force (IETF) under RFC 6455. This communication protocol is essential for enabling concurrent data transmission between the control device 100 and the server 310, which facilitates the dynamic interaction between the user's inputs and the VR environment. This capability is crucial for the execution of platform-specific commands generated by the AI-powered code generator. The Semantic Interaction System 200 is designed to support future full-duplex Internet communication protocols that may provide enhanced performance and expanded functionalities, ensuring that the system's architecture remains adaptable and robust across evolving technological standards.

The system's adaptability extends to its capacity to address a broad spectrum of accessibility needs, ensuring that it remains usable by individuals with various impairments, including visual, auditory, cognitive, and motor disabilities. Central to this adaptability is the use of DIS, which abstracts user interactions into high-level intents that are universally interpretable across different platforms and devices. This abstraction allows the system to dynamically adjust user interfaces and interaction methods, providing a consistent and accessible experience that caters to individual user needs. By minimizing the complexity of interactions, the system enables users to engage with the digital environment through simplified commands and gestures, reducing cognitive and physical demands.

The architecture includes Custom Connectors that translate the high-level intents defined by DIS into device-specific commands, ensuring that the accessibility needs of users are addressed at the interface level. For example, the Custom Connectors can automatically adjust the size of on-screen elements, provide auditory cues, or enable alternative input methods such as voice commands or switch controls, depending on the user's accessibility settings. This adaptability is vital for users who may find traditional input devices challenging, allowing them to interact with the system using the most suitable input method for their abilities.

To further enhance accessibility, the system incorporates flexible content control logic that dynamically adjusts the presentation of information based on the user's accessibility profile. This profile includes preferences and settings that specify the user's needs, such as text-to-speech output for visually impaired users, high-contrast displays for users with low vision, and simplified navigation paths for users with cognitive disabilities. The content control logic continuously monitors and adapts the user interface to ensure that it remains aligned with the user's accessibility requirements, making real-time adjustments as necessary to optimize the user experience.

The control device 100 utilizes its integrated sensors and communication interfaces to detect and respond to the user's interaction patterns and preferences. For instance, if a user experiences difficulty with fine motor movements, the system can recognize this and adjust the interface by enlarging touch targets or simplifying gesture requirements. The system also supports voice command input and audio feedback mechanisms, offering a multimodal interaction approach that enhances accessibility for users with diverse physical and sensory impairments. In VR environments, this adaptability includes providing spatial audio cues and haptic feedback to assist users with navigation and interaction within the virtual space.

For users with limited vision, the system employs spatial audio cues to offer directional information and context, enhancing spatial awareness within the VR environment. For example, the system can generate audio prompts indicating the location of interactive elements, obstacles, or navigational aids. This spatial audio is processed through the control device's audio output interfaces and synchronized with the user's movements within the VR environment, delivering real-time feedback that enhances navigation and interaction accuracy. Haptic feedback mechanisms complement these auditory cues, providing tactile signals that alert users to changes in the interface or confirm interactions, ensuring a multi-sensory and accessible user experience.

The system's content control logic not only adjusts visual and auditory elements but also adapts the interaction flow based on the specific needs of users with limited vision. For instance, the system can streamline navigation by prioritizing essential content and commands, reducing the complexity of the interface, and minimizing the steps required to complete common tasks. By simplifying these pathways, the system reduces cognitive load and enhances accessibility, allowing users to engage more effectively with the VR environment.

Additionally, the system is designed to integrate seamlessly with external accessibility tools commonly used by visually impaired individuals, such as braille displays and external screen readers. The control device 100 communicates with these tools via standard accessibility protocols, ensuring compatibility and integration that allow users to employ their preferred assistive devices alongside the system. This interoperability extends the system's accessibility features, providing a comprehensive and adaptable solution that meets the needs of users across a wide range of digital environments, including 2D interfaces, VR, and AR platforms.

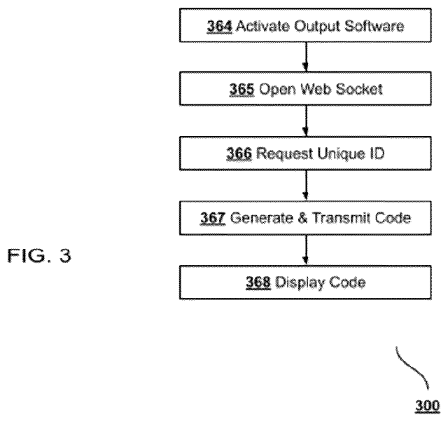

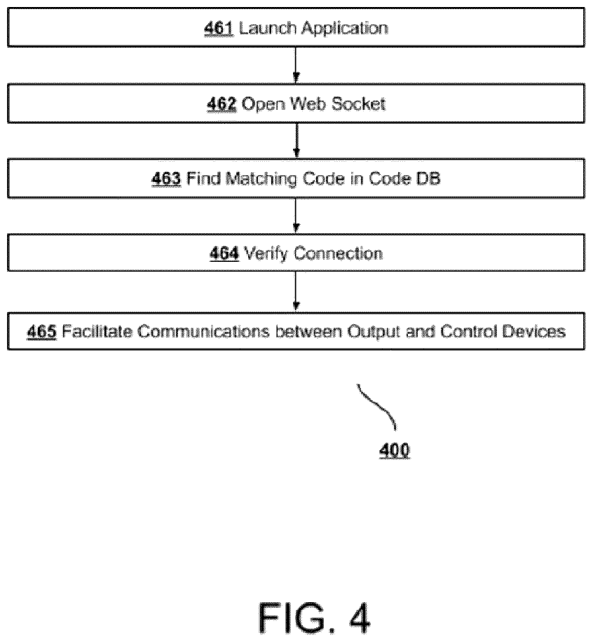

FIGS. 3 and 4 depict methods 300 and 400, which detail the processes for connecting and controlling an output device 120 using a control device 100 via the Semantic Interaction System 200. Method 300, illustrated in FIG. 3, begins at step 364, where the output software 220 is activated on the output device 120. In step 365, the output software 220 initiates a WebSocket connection 350 with the server 310 using a secure protocol, such as HTTPS 205, 351. In step 366, the output software 220 requests a unique identifier from the server 310. At step 367, the server 310 generates a unique alphanumeric code 315, which is transmitted to the output device 120 via the WebSocket connection 350. Subsequently, in step 368, the output device 120 displays this code 315 as a QR code 225, allowing control devices 100 to scan the code, thereby facilitating the linking and recognition of high-level intents as defined by the Dynamic Interaction Specifications (DIS).

Method 400, shown in FIG. 4, outlines the connection process between a control device 100 and an output device 120 via the server 310. The method commences at step 461, where the user launches application 106 on the control device 100, establishing a WebSocket connection 355 with the server 310 in step 462. In step 463, the control device 100 scans the QR code 225 displayed on the output device 120, transmitting the scanned code 315 back to the server 310. The server 310 matches this code to the corresponding WebSocket connection 350 associated with the output device 120, utilizing the code database 330. In step 464, the connection is verified through a handshake or a confirmation display, completing the linkage between the control device 100 and the output device 120. In step 465, the server 310 manages all subsequent communications and control commands between the devices via the established WebSocket connections 350 and 355, ensuring that the interactions align with the high-level intents defined by the DIS, thus providing a platform-independent framework for consistent user experiences.

The Semantic Interaction System 200 employs persistent communication connections to enable continuous, bidirectional communication between the control device 100 and the output device 120 via the server 310. While a preferred embodiment utilizes WebSocket connections standardized under RFC 6455, the disclosed system is not limited to this configuration. Other suitable communication protocols that provide persistent, full-duplex data exchange, such as HTTP/2, MQTT, gRPC, or any equivalent protocol capable of supporting real-time interactions, may also be employed without departing from the scope of the disclosed embodiments. These protocols are crucial for the dynamic interpretation and execution of high-level intents as defined by DIS, thereby maintaining the system's adaptability across various communication standards.

The system supports the concurrent connection of multiple control devices 100 to a single output device 120, allowing for collaborative interactions with the output software 220. In one embodiment, the server 310 operates as a cloud-based service, leveraging Internet 320 connectivity to allow control devices 100 to transmit user inputs and commands to the server 310. The server 310 subsequently adjusts the content presentation on the output device 120 according to the device's specifications and user preferences. This dynamic adjustment is guided by the high-level intents specified by the DIS, ensuring that content delivery and interaction management remain consistent across different control and output devices.

To optimize performance, the system may offload content rendering and control logic to a lightweight graphics engine on the output device 120, thereby reducing the computational burden on the server 310. This configuration enables the display of context-specific content from the content database 335, which is tailored by the content control logic within the matching engine 306. The matching engine 306 applies business rules based on the output device's attributes, such as IP address and location, to ensure that the content adjustments align with the defined high-level intents, enhancing the accessibility and usability of the system across diverse output platforms.

The distribution of the code 315 can be achieved through multiple methods, including direct display on the output device 120, printing on physical media, or presentation via a dedicated code output device 210. Each code, typically represented as a QR code 225, is generated by either the server 310 or the output device 120, enabling seamless connections that link user actions on control devices 100 to the corresponding content and controls on output devices 120. The system utilizes platform-independent representations of user interface elements, executed through dynamically selected Custom Connectors, which are generated based on high-level intents defined by the DIS, ensuring harmonized interactions across various platforms.

The Semantic Interaction System 200's architecture ensures consistent interpretation and execution of high-level intents across multiple environments by utilizing AI-powered code generation to dynamically create Custom Connectors. These connectors translate user interface elements into platform-agnostic actions, automatically adjusting to the specific capabilities and contexts of various devices. This AI-driven approach addresses accessibility challenges such as visual impairments, cognitive overload, and dexterity limitations, providing a robust and adaptable framework that continuously learns and refines user interactions.

Central to the system's functionality is the integration of DIS, which serves as a universal language for high-level intents, enhancing the system's resilience and scalability. By employing DIS, the system can dynamically adapt to different user needs and device capabilities, delivering an inclusive and efficient user experience across diverse digital environments. This adaptability is critical for maintaining consistent and accessible interactions within VR environments, ensuring that the user's high-level intents are accurately translated into executable commands by the VR headset and other output devices.

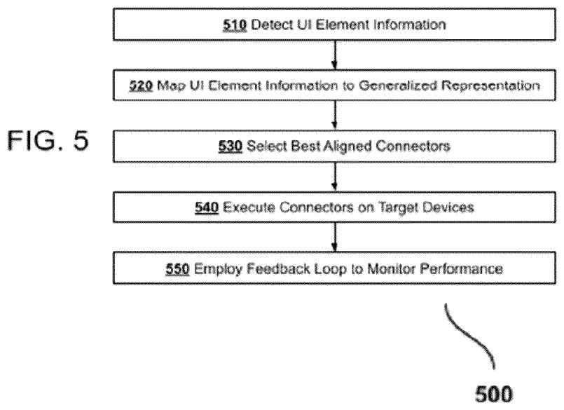

FIG. 5 illustrates the Semantic Interaction System 200, designed to facilitate adaptive user interactions across diverse platforms by translating user interface elements into high-level intents using the Dynamic Interaction Specification (DIS). The DIS serves as a comprehensive framework that encapsulates user actions into platform-independent representations, enabling the execution of these high-level intents through dynamically generated Custom Connectors tailored to specific output devices, such as VR headsets and pointing devices.

The process begins at step 510, where the system detects user interface elements on control devices 100, such as buttons, links, sliders, or other interactive components. These user interface elements are identified and mapped to corresponding high-level intents defined by the DIS. This mapping ensures that user interactions are consistently interpreted and adapted across various platforms, including 2D interfaces, VR environments, and screen readers. The DIS framework abstracts these interactions from device-specific functionalities, allowing the Semantic Interaction System 200 to maintain consistent usability and accessibility across a wide range of output devices 120, which may include VR headsets, touchscreens, and audio-only interfaces.

In step 520, the system employs the Dynamic Interaction Specification (DIS) as a flexible and platform-agnostic framework for defining high-level intents. The DIS abstracts user interactions from the specific functionalities of individual devices, enabling the Semantic Interaction System 200 to interpret intents such as navigating menus, executing commands, or adjusting settings consistently, regardless of the underlying platform. This abstraction is critical for maintaining accessibility and usability across diverse output devices 120, ensuring that the system can cater to a broad spectrum of user needs and device capabilities.

In step 530, the high-level intents defined by the DIS are processed through the server 310, where the matching engine 306 utilizes AI-powered code generation to dynamically generate and update the appropriate Custom Connectors for each output device 120. Unlike traditional API-based systems that rely on static specifications, the Semantic Interaction System 200 employs DIS to allow for the creation of platform-specific commands that are not fixed but rather dynamically interpreted based on real-time data and context. This AI-driven adaptability ensures that the connectors align with the evolving capabilities and preferences of each device, enabling a fluid and responsive user experience without the limitations imposed by traditional API definitions.

Further, as demonstrated in step 540, the system employs AI-powered code generation to dynamically generate and deploy Custom Connectors in scenarios where predefined connectors are insufficient or unavailable. This process involves real-time mapping of user inputs to platform-independent actions as defined by the DIS, which are then translated into device-specific commands. By avoiding the fixed nature of API specifications, the system ensures that interactions remain flexible and can be continuously refined and optimized based on performance feedback and user needs, thereby enhancing the overall accessibility and usability of the system across diverse platforms.

The system's architecture integrates AI-powered feedback loops to continuously monitor and assess the performance of deployed Custom Connectors in real-time, as shown in step 550. This adaptive approach allows the system to iteratively refine and optimize the Custom Connectors, enhancing their responsiveness and alignment with user interaction needs based on performance data and contextual analysis. By leveraging DIS, which avoids the rigid constraints of fixed API commands and parameters, the system proactively identifies opportunities for further optimization, making dynamic adjustments that ensure it evolves seamlessly to meet changing user requirements and device capabilities.

By integrating these processes, the Semantic Interaction System 200, as depicted in FIG. 5, provides a robust, scalable, and accessible framework for managing complex user interactions across various digital environments. The system's architecture abstracts user interface elements into high-level intents using DIS and employs a dynamic, iterative approach to connector generation, ensuring that user inputs are accurately interpreted and executed. This approach effectively addresses accessibility challenges, such as visual impairments, cognitive overload, and dexterity limitations, standardizing interactions while adapting to the unique characteristics of each output device.

FIG. 6 illustrates the Dynamic Interaction Specification (DIS) framework utilized within the Semantic Interaction System 200 to translate user interface elements into platform-independent high-level intents. This figure details various high-level intents, such as “Navigate_Interface,” “Control_Component,” and “Adjust_Parameter,” each associated with specific parameters and adaptable behaviors that are tailored to different interaction contexts, including voice, touch, and multimodal inputs. The DIS framework allows for flexible adaptation of user actions, providing commands that can be executed across diverse platforms without being tied to specific hardware functionalities. For example, the intent “Navigate_Interface” might be used to control menu navigation in a VR environment or adjust settings on a touchscreen device, demonstrating DIS's ability to maintain consistency and adaptability in interaction flows across varying device types and user needs. The DIS framework, as depicted in FIG. 6, supports the system's goal of enhancing accessibility and usability by standardizing the interpretation of user intents, thereby enabling seamless, platform-agnostic interactions within the Semantic Interaction System 200.

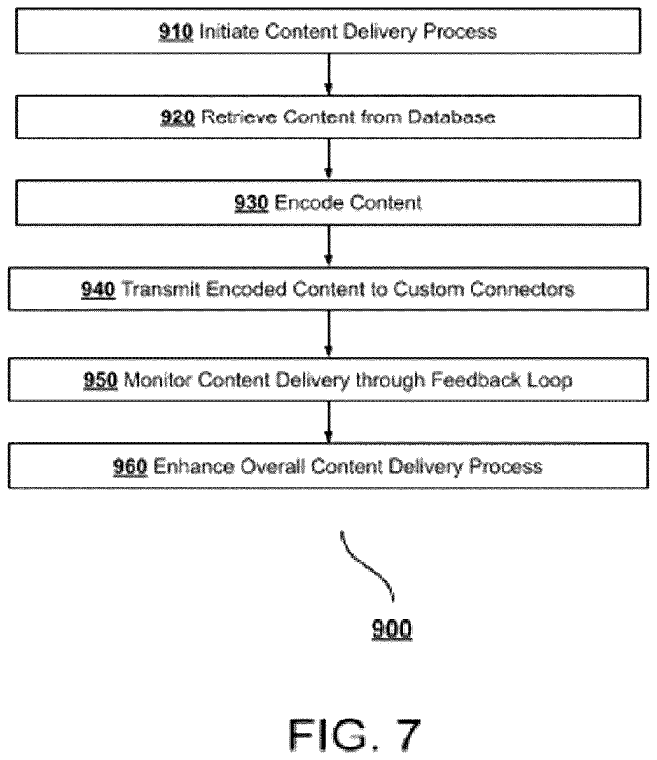

FIG. 7 illustrates a comparative analysis between two interaction methods within the Semantic Interaction System 200: Method 1, which focuses on 3D spatial navigation, and Method 2, which emphasizes AI-powered autonomous navigation. The table in FIG. 7 highlights key aspects such as interaction style, navigation control, action sequences, feedback and confirmations, and accessibility focus. Method 1 involves user-directed navigation, where the user interacts directly with the virtual environment using manual inputs, such as gestures or controller movements. This method provides real-time visual and auditory feedback, enhancing the user's sense of control and immersion, making it suitable for users who are comfortable with active engagement in 3D spaces.

In contrast, Method 2 employs AI-driven navigation, reducing the need for direct manual input by autonomously guiding the user through virtual environments based on high-level intents defined by the Dynamic Interaction Specification (DIS). This method is particularly beneficial for users with visual impairments or limited manual dexterity, as it offers a hands-free and eyes-free interaction experience. By leveraging DIS, the system dynamically adapts the interaction flow, providing contextual audio cues and confirmations that align with the user's intents, ensuring that the system remains accessible and responsive to individual needs. The comparison in FIG. 7 demonstrates the flexibility of the Semantic Interaction System 200 in catering to diverse user preferences and accessibility requirements, illustrating how DIS, Custom Connectors, and feedback mechanisms work together to deliver a tailored, platform-agnostic user experience.

FIG. 6 also illustrates Method 800, an embodiment of the Semantic Interaction System 200, specifically configured to enhance accessibility for visually impaired users within virtual reality (VR) environments by employing Custom Connectors, integrated audio feedback, and a voice command input system. This configuration features a VR headset equipped with audio feedback capabilities paired with a voice command interface that translates high-level intents into concise, context-aware audio prompts, guiding the user through the VR environment. The system leverages Dynamic Interaction Specifications (DIS) to define these high-level intents, ensuring that interactions remain consistent, intuitive, and adaptable across various scenarios.

The system utilizes Custom Connectors to convert platform-independent actions into platform-specific commands executable by various output devices, including VR headsets and pointing devices. In step 810, these Custom Connectors dynamically translate user intents, such as “navigate to the main menu” or “select an option,” into immediate and relevant feedback. This feedback is delivered through simplified audio prompts or visual highlights, reducing the cognitive load typically associated with traditional screen readers and minimizing the reliance on memory for navigating complex interfaces. By adhering to the DIS framework, the system ensures that each action remains aligned with the high-level intents defined for seamless execution across diverse VR interactions.

In step 820, the system delivers context-specific audio feedback, focusing solely on the most relevant information needed for the user to make informed decisions and interact effectively within the VR space. For instance, when the user gestures towards a particular area or object, the system provides an audio cue that describes the object and suggests potential actions, such as “You are pointing at the settings icon; say ‘Open settings’ to proceed.” This targeted feedback enables users to maintain orientation and control without visual input, significantly enhancing their ability to navigate and engage with the virtual environment. The use of DIS ensures that these feedback loops are consistently tailored to the user's intents, providing a cohesive and user-friendly experience.

The system dynamically adjusts feedback based on situational representations of user interface elements, ensuring that user interactions remain intuitive and accessible. For example, when navigating a virtual room with interactive objects such as a door or light switch, and the user voices a command relevant to the light switch, the system provides a specific prompt: “You are pointing at a light switch; say ‘Toggle lights’ to turn them on or off.” This approach ensures that feedback remains specific and actionable, enhancing the user's ability to interact smoothly with the VR environment by providing immediate, contextually tailored action suggestions. The use of DIS allows for these adjustments to be made dynamically, keeping the feedback relevant to the user's current context and intents, thereby fulfilling the system's goal of abstracting interactions into high-level intents that are universally interpretable.

In another scenario, during a virtual presentation, the system automatically generates concise descriptions of slide content relevant to the user's focus. For instance, when the user gestures towards a slide with a bar chart, the system might say, “This slide shows a bar chart with quarterly sales figures, highlighting a 20% increase in Q2.” This capability allows the system to transform complex visual data into succinct audio summaries that align with the user's situational needs, minimizing unnecessary details and concentrating on the most pertinent information. This approach, guided by the DIS, ensures that all feedback provided is relevant and streamlined, facilitating a more accessible and engaging user experience, consistent with the requirement to support simplified input interactions within the VR environment.

In step 830, the system emphasizes the use of voice commands to confirm actions or navigate menus with minimal manual input, directly addressing the needs of users who may find traditional VR controls, such as 6-DoF gamepads, overly complex due to their reliance on multiple buttons and precise hand movements. By utilizing voice commands, the system offers an efficient and accessible alternative to tactile controls, which may be cumbersome for visually impaired users. This approach provides a responsive interaction option that caters to users with varying levels of dexterity, allowing actions to be easily executed through voice input, thus enhancing accessibility in line with the high-level intents defined by the DIS.

In step 840, the Custom Connectors ensure that each user action is matched with the appropriate feedback and interaction sequence, tailored to the user's needs and the capabilities of the VR platform. For instance, when the user intends to “start a new activity,” the Custom Connector sequences the required steps, such as navigating to the activity menu, highlighting the correct option, and initiating the action. This process is guided by concise audio feedback and voice command inputs, enabling visually impaired users to perform complex interactions through a series of straightforward steps, thus enhancing the overall user experience within the VR metaverse. The use of DIS ensures that these sequences are consistently aligned with the user's high-level intents, allowing for a coherent and fluid interaction experience.

Additionally, the system extends its situational representations to include error correction and contextual guidance. For example, if a user attempts to open a locked door without a key, the system provides targeted feedback: “The door is locked; you need a key. Say ‘Find key’ to locate the nearest key.” This adaptive feedback offers specific, actionable advice that directly addresses the user's immediate needs without overwhelming them with extraneous information. Such mechanisms ensure that visually impaired users can efficiently navigate and interact with complex VR environments, fostering a more accessible and user-friendly experience. The integration of DIS allows the system to dynamically adjust its responses based on real-time user actions, continuously aligning feedback with the user's intents to support effective interaction management.

FIG. 7 illustrates Method 900, detailing the process of content delivery aligned with the Dynamic Interaction Specification (DIS) and Custom Connectors within the Semantic Interaction System 200. This method ensures that content is delivered according to high-level intents processed by Custom Connectors, optimizing the user experience across diverse interaction environments, including 2D interfaces, VR, and AI-driven systems. By leveraging the DIS, the system maintains a consistent and adaptable approach to content delivery, dynamically tailoring interactions to suit the specific capabilities of each platform, thereby enhancing accessibility and usability.

In step 910, the server 310 initiates the content delivery process by referencing the content control logic embedded within the matching engine 306. This logic determines the appropriate type and format of content to deliver based on high-level intents derived from user interface elements and interpreted through DIS. The content control logic utilizes dynamically generated Custom Connectors, which are tailored for specific control devices and output devices 120, along with user-specific data stored in the content database 335. This integration ensures that content delivery aligns with user preferences, device capabilities, and the platform-independent actions specified by DIS, providing a customized and accessible user experience that caters to the unique needs of each interaction context.

In step 920, the server 310 retrieves the selected content from the content database 335, ensuring that it aligns with the interaction model and technical specifications of both the control device 100 and the output device 120, such as the VR headset. This process takes into account factors like display capabilities, processing power, and user preferences, thereby adapting the content to meet the specific requirements of each device. The system preserves the integrity and accessibility of the content during delivery, dynamically adjusting the content presentation to align with the user's high-level intents in a platform-agnostic manner. By referencing the Dynamic Interaction Specifications (DIS), the system ensures that the content delivery is consistent and fluid across various platforms, enhancing the overall user experience.

Furthermore, the system integrates real-time user inputs from the pointing device into the AI-powered code generator via the server 310. This integration allows the system to dynamically adjust Custom Connectors based on these inputs, refining the platform-specific commands generated for the VR headset and other output devices. The feedback loop between the pointing device, the AI-powered code generator, and the Custom Connectors ensures that each user action is accurately translated into immediate and relevant responses within the VR environment, maintaining the consistency of interactions as defined by the DIS.

In step 930, the server 310 prepares the content for delivery by encoding it into a format compatible with the selected Custom Connector. This encoding process involves adapting the content to meet the platform-specific requirements dictated by the Custom Connector, guided by the high-level intents defined in the DIS. For example, video content may be converted into a 3D format suitable for VR environments, or text may be optimized for structured audio output in screen reader setups. By adhering to the guidelines set forth in the DIS, the system ensures that content remains accessible and consistent with the user's intended interaction, regardless of the platform, enabling the Semantic Interaction System 200 to deliver content finely tuned to the capabilities of each output device, thereby enhancing usability and user satisfaction across diverse interaction environments.

In step 940, the server 310 transmits the encoded content to the output device 120 via the established communication connection. The Custom Connector receives the content and processes it for display or execution on the output device 120. For instance, in a VR environment, the content may be rendered as immersive 3D graphics, while in a screen reader configuration, the content may be delivered as structured audio feedback. The Custom Connector ensures that the content presentation aligns with the high-level intents mapped from the user interface elements, maintaining a seamless and coherent user experience across various platforms, thereby fulfilling the user's interaction expectations.

In step 950, the server 310 continuously monitors the content delivery process through feedback mechanisms integrated within Custom Connectors. This feedback loop assesses performance metrics and user engagement with the delivered content, making real-time adjustments as necessary to optimize content presentation. The server 310 leverages real-time analytics and user feedback to refine the content control logic and update the content database 335, ensuring that future content deliveries are precisely aligned with platform-independent actions and tailored to user needs. These feedback mechanisms enable the system to dynamically adjust interaction options based on user actions within the VR environment, thereby enhancing usability by reducing manual navigation.

In step 960, the Semantic Interaction System 200 utilizes feedback data to enhance the overall content delivery process, dynamically adapting to changes in user behavior, device performance, or environmental conditions. This adaptive approach enables the system to provide a personalized and responsive user experience, addressing accessibility challenges such as visual impairments, cognitive overload, and dexterity limitations by delivering content in the most appropriate and accessible format for each user. By continuously refining its delivery processes based on real-time data, the system ensures that the high-level intents defined by the DIS are met effectively and consistently across varying contexts.

Method 900 completes the integration of Custom Connectors with content delivery, ensuring that the Semantic Interaction System 200 provides a consistent and accessible experience across diverse platforms. By aligning content delivery with the specific capabilities of each Custom Connector and the underlying platform-independent actions, the system effectively bridges the gap between user intent and platform-specific execution, delivering a unified and adaptive user experience that meets the needs of a broad range of users. The seamless integration of DIS, Custom Connectors, and feedback mechanisms underscores the system's capacity to dynamically adapt to user requirements, offering a robust solution for content management in varied interaction environments.

1. A system for integrating Dynamic Interaction Specifications (DIS) to facilitate high-level intents within a virtual reality (VR) environment, the system comprising:
(a) a VR headset configured to provide immersive virtual experiences and support simplified input interactions within the VR environment;
(b) a pointing device operable by a user, the pointing device configured to offer input mechanisms that enable the user to interact with virtual elements with minimal manual effort; and
(c) a server, the server comprising:
(i) an AI-powered code generator configured to dynamically create one or more Custom Connectors that translate high-level intents into platform-specific commands executable by the VR headset and the pointing device; and
(ii) a code database configured to store unique Accessibility Link Codes, each Accessibility Link Code encoding high-level intents derived from user interface elements within the VR environment, as defined by the Dynamic Interaction Specifications (DIS); wherein the server is further configured to:
(i) associate an Accessibility Link Code in the code database with the VR headset and the pointing device, translating descriptions of server application SDKs and their associated APIs into high-level intents encoded in the Accessibility Link Code, wherein the APIs define methods for interacting with the functionalities of content generated using the SDKs;
(ii) receive user inputs from the pointing device and use these inputs to engage with the AI-powered code generator and the one or more Custom Connectors to translate the high-level intents encoded in the Accessibility Link Code into platform-specific commands executable by the VR headset; and
(iii) implement feedback mechanisms that dynamically adjust interaction options based on the user's actions within the VR environment, thereby enhancing usability by reducing the need for manual navigation; wherein the system is configured to employ Dynamic Interaction Specifications that abstract adaptive user interactions into high-level intents, without being limited by fixed commands, endpoints, and parameters, thereby ensuring the high-level intents are interpretable by both the VR headset and the pointing device.

2. The system of claim 1, further comprising:
(a) a content database configured to store various types of interactive content, including text, graphics, video, multimedia, and other interactive elements, generated usingSDKs from applications, such as websites or web apps;
(b) wherein the server interacts with the content database using APIs associated with the SDKs to define how the interactive content is generated, adapted, and integrated according to the high-level intents specified by the Dynamic Interaction Specifications (DIS); and
(c) wherein the server is further configured to:
(i) retrieve content from the content database based on user interactions and high-level intents derived from the DIS, ensuring the content is formatted and delivered for execution on both the VR headset and the pointing device; and
(ii) utilize content control logic to dynamically adapt content delivery in real-time, aligning the content with device capabilities and user preferences as specified by the Accessibility Link Codes, thereby ensuring consistency and accessibility across various platforms.

3. The system of claim 1, wherein the server further comprises a feedback module configured to monitor user interactions within the VR environment and dynamically adjust the functionality of the Custom Connectors, enhancing user engagement by providing context-sensitive feedback through the VR headset.

4. The system of claim 1, wherein the VR headset is further configured to provide multimodal feedback, including visual, auditory, and haptic cues, to reinforce the user's sense of presence and improve the intuitiveness of the interactions within the VR environment.

5. The system of claim 1, wherein the AI-powered code generator utilizes machine learning algorithms to refine the Custom Connectors based on real-time user data, continuously optimizing the platform-specific commands to align with evolving user preferences and interaction patterns.

6. The system of claim 1, wherein the pointing device includes motion sensors and a communication module configured to detect and transmit user gestures, enabling the execution of high-level intents in the VR environment through gesture-based controls.

7. The system of claim 1, wherein the Dynamic Interaction Specifications (DIS) further define accessibility features, including alternative input methods such as voice commands and simplified gesture controls, to accommodate users with disabilities or limited manual dexterity.

8. The system of claim 1, wherein the server is further configured to interface with external databases, including user profile databases and content libraries, to personalize the VR experience based on user-specific preferences, historical interaction data, and accessibility needs.

9. The system of claim 1, wherein the Custom Connectors are dynamically updated by the server in response to changes in the VR environment, including the addition of new interactive elements or modifications to existing ones, ensuring continuous alignment with the high-level intents defined by the Dynamic Interaction Specifications (DIS).

10. The system of claim 1, further comprising a network communication module configured to facilitate real-time synchronization of user interactions across multiple control devices and VR headsets, enabling collaborative VR experiences by sharing high-level intents and corresponding platform-specific commands between users.
